(19) United States
(12) Patent Application Publication
(10) Pub. No.: US 2026/0005758 A1
(43) Pub. Date: Jan. 1, 2026

(54) OPTICAL INTERCONNECTS FOR FLEXIBLE CALIBRATION OF AN OPTICAL TRANSCEIVER IN A FREE-SPACE OPTICAL COMMUNICATION SYSTEM

(71) Applicant: Altera Corporation, San Jose, CA (US)

(72) Inventors: Conor O'KEEFFE, Passage West (IE); Finbarr O'REGAN, Innishannon (IE); Ricard MENCHON ENRICH, Barcelona (ES); Anthony KELLY, Monanooag Townland (IE); Adam HERRMANN, Kilteevan (IE)

(21) Appl. No.: 19/207,426

(22) Filed: May 14, 2025

Related U.S. Application Data
(63) Continuation of application No. PCT/US2024/035941, filed on Jun. 28, 2024.

(51) Int. Cl. H04B 10/035; H04B 10/079

(52) U.S. Cl. CPC H04B 10/035; H04B 10/079

(57) ABSTRACT

Disclosed herein are devices, systems, and methods for selectively configuring an optical coupling network between a modem and optical head to calibrate the timing delay of the entire receive path and entire transmit path. The device includes a modem with a transmit and receive path and an optical head with an optical transmit path, an optical receive path, and a calibration path. The device includes an optical coupling network for selectively routing signals (i) through a first loopback path comprising the transmit path and the receive path; (ii) through a second loopback path comprising the transmit path, the optical transmit path, the optical receive path, and the receive path; (iii) through a third loopback path comprising the transmit path, twice the calibration path, and the receive path; and (iv) through a fourth loopback path comprising the transmit path, the calibration path, the optical receive path, and the receive path.

### CROSS-REFERENCE TO RELATED APPLICATION(S)

This application claims priority to International Application PCT/US2024/035941 filed on Jun. 28, 2024, the contents of which is fully incorporated herein by reference.

### BACKGROUND

Global positioning system (GPS) is a satellite-based system that has become the de facto standard for planetary navigation. As popular and helpful as GPS is, several weaknesses remain, and in particular, GPS remains susceptible to jamming, long acquisition times, and other disruptions in the ability of a device on the Earth's surface to communicate with a GPS satellite. This is because the signal strength of the GPS system at the Earth's surface is often very low (e.g., often less than −125 dBm at the input of the receiver of the device), given that the signal transmission originates from a high altitude orbit (e.g., medium Earth orbit (MEO)). In addition, accuracy is often limited due to limited satellite visibility.

Other tracking systems based on lower altitude orbit satellites (e.g., low Earth orbit (LEO) satellite constellations) may be capable of providing a stronger on-ground signal because of the shorter distance between such satellites and the device on Earth. In addition, more satellites may be available as points from which the device may triangulate. Thus, LEO satellite constellations may be desirable for their better resilience against jamming/blocking, better accuracy, and faster acquisition times. Irrespective of the type of satellite constellation, in order to accurately provide positioning, it may be important to have highly accurate time synchronization among satellites in the constellation, often synchronized via optical communications among satellites in the constellation. The accuracy of such time synchronization may depend on the internal time of flight of the optical signal and its propagation delay through the optical transmitter and optical receiver, optical interconnects, and other internal electronic circuits. However, the delay may vary as a function of operating wavelength, physical cables, temperature, and even the mechanical position of the optical systems.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of numerous satellites orbiting a planet, where the satellites communicate to form a mesh network;

FIG. 2 depicts an example schematic of a satellite that may be used in a satellite constellation in which satellites may communicate with one another over an optical inter-satellite link (OISL);

FIG. 3 illustrates an example graphic depiction of an optical coupling network that may be used for calibrating the delay through an optical head and modem (including interconnects) for both the transmit path and the receive path, individually;

FIG. 4 shows an example of how the optical coupling network may be included (at least in part) in a photonics integrated circuit;

FIG. 5 shows an example algorithm flowchart of a calibration process that uses an optical coupling network to make loopback measurements in order to determine a time delay calibration for a transmit path and a receive path, individually; and

FIG. 6 depicts an example schematic flow diagram of a method for determining a calibration delay using an optical coupling network to configure and measure different loopbacks.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, a state machine, a state machine controller, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals or optical signals, where the physical transmission and reception is handled by radio-layer components such as radio frequency (RF) transceivers and antennas or in the case of optical, optical layer components, and the logical transmission and reception over the software-level connection is performed by the processors or controllers or network switch components. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations. References to the TX/RX “chain” or “path” refer to the series of processing steps to convert, modulate, amplify, filter, etc. the signal to be transmitted (along the TX path) from the antenna or to the series of processing steps to convert, modulate, amplify, filter, etc. the desired signal (along the RX path) that is to be recovered from the received signal at the antenna. References to a “desired” signal refer to the predefined signal that is to be received by the communication device at the prescribed time.

As noted above, time synchronization among satellites operating together to provide location services may be critical to the accuracy of the location information. To time-synchronize, satellites often communicate with one another via optical interfaces (e.g., an optical inter-satellite link (OISL). Signals communicated over the OISL links may be timestamped (e.g., as a header in an OISL frame) so as to allow Coordinated Universal Time (UTC) to be propagated across the satellites in the satellite constellation. Because the speed at which satellites are traveling, the accuracy of the time-base on each satellite must be on the order of a few nanoseconds so as to keep the accuracy of any location-based tracking to a few centimeters on Earth. Accurate time synchronization and time-stamping may also be important to security, where “spoofed” signals may be discarded if the timestamps fall outside the expected time window. The narrower this window may be defined, the higher the security against spoofing, but a narrow window also means that the satellites in the constellation must synchronize with a high level of accuracy. Accurate time-stamping may also be helpful for position, navigation, and timing (PNT) of the satellite itself, ensuring that the satellites target orbit position is maintained and known.

The accuracy of relayed timestamps generated on each satellite depends on a calibration of the time-of-flight of the internal signal and propagation delay through the optical transmitter, the optical receiver, optical interconnects, and other internal electronic circuits. Because this internal delay may vary as a function of the operating wavelength, the physical cables, the temperature, aging, and even the mechanical position of the optical systems on the individual satellite, it may be important to calibrate the internal delays of the satellite after it has been deployed (e.g., in orbit), rather than only during its manufacturing/assembly.

Disclosed in more detail below is an optical coupling network that provides for calibrating the internal time of flight of an optical system on a satellite, where the time of flight includes the processing delays in the OISL terminal equipment. Until now, such equipment delays have only been estimated or measured at manufacturing, but the feedback network and calibration disclosed below provides a way of accurately measuring the time of flight of the internal optical pathways for a deployed satellite—for both the transmit path as well as, individually, the receive path—so that the calibration is not only satellite specific but also deployment- and environment-specific such that a satellite may be re-calibrated in its environment after deployment and under its current operational configuration (e.g. frequency range). Many satellite terminals in the manufacturing process have the optical fiber interconnect between modem and optical head cut and spliced to fit cable looms paths. As such, the exact length of interconnect fiber is not accurately known, adding an unquantifiable error to optical signal propagation delays without using the optical coupling network and calibration discussed in more detail below. The calibrated delay may be determined individually for each of the transmit path and the receive path, from substantially the aperture lens of the optical head to the digital signal processor of the modem. As should be appreciated, while the disclosed system is described herein with examples directed to a satellite and satellite networks, it should be understood that the same optical coupling network and calibration may be applied to any type of free space optical terminal, including those that communicate over earth-space links and those that communication between or to vehicles such as drones, aircraft, ships, railcars, fixed point install terrestrial free-space optics links, etc.

Such an optical coupling network and calibration may be particularly beneficial to enable, for example, LEO constellations of satellites to accurately time-synchronize their clocks over OISL links. In particular, the disclosed calibration may allow the system to determine individual/independent delays for the transmit path and the receive path. The calibration may be performed in both a pre-deployment (on-ground during manufacturing/assembly of the satellite system) state and in post-deployment (e.g., in orbit) state, where the post-deployment calibration may be particularly helpful in calibrating-out aging-related effects, motion-related effects, environmental-related effects, and different operational configurations (e.g., wavelength of operation) over time.

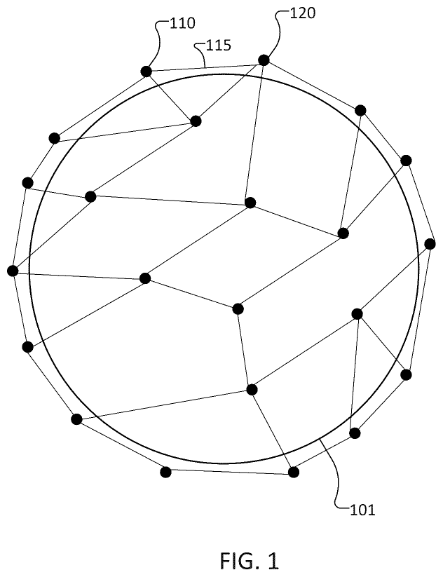

In the context of satellite networks, FIG. 1 shows an example of numerous satellites that are orbiting a planet 101 (e.g., Earth), where the satellites communicate to form a mesh network. The satellites are depicted as dots, two of which are labeled as satellite 110 and satellite 120. The satellites may be in LEO, MEO, GEO, etc., or any other type of orbit or combination thereof. Each of the satellites may form optical inter-satellite links (OISLs) with other satellites in the network, an example link of which is labeled as link 115. OISL links may also be made with other terrestrial objects such as aircraft, ground stations, etc. The communicable satellites may also be in different orbital planes. The satellites in the network may be configured to send data, including timing information, to one another over OISL links. In this sense, when two or more satellites are capable of relaying information to one another, a mesh network is formed among the satellites. Due to the motional orbit of the satellites and depending on their respective orbits, a satellite may need to change its active connection with a first satellite to an active connection with a different satellite. For LEO satellites, for example, the OISL link range with another satellite may be limited to approximately 5000 km, owing to the plant horizon obscuring the view. For other orbit links, such as MEO or GEO, the link range may be much farther, up to 45,000 km in some cases.

To enable optical communications, the satellite must point an optical laser to another satellite, which may require accurate tracking of and pointing to the connected target satellite. In LEO orbits, for example, where a satellite may have a velocity of 25,000 km/hr, the satellite may orbit the Earth in approximately 90 mins. Satellite constellations may include thousands of satellites.

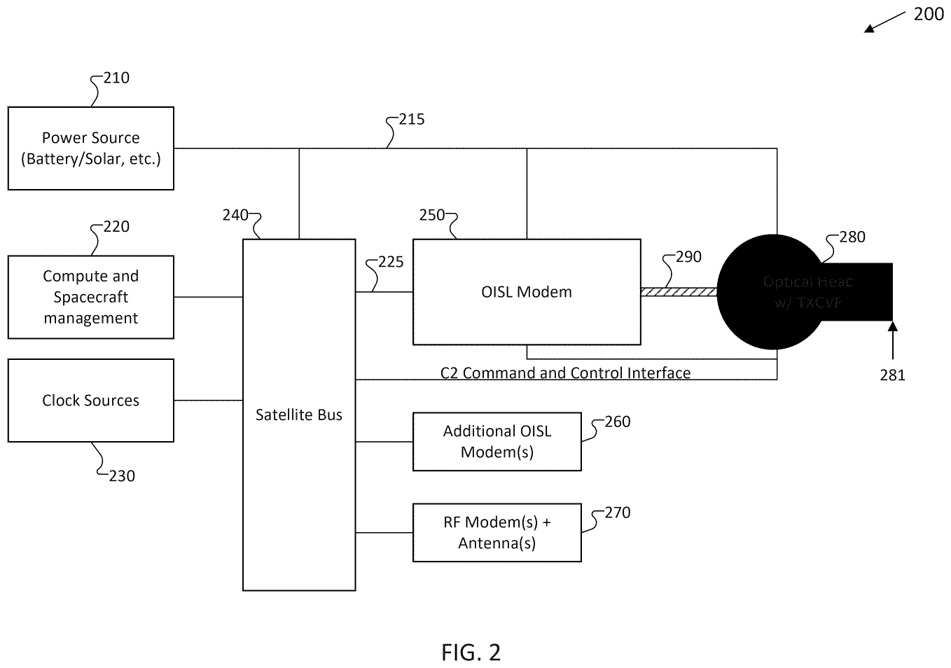

FIG. 2 shows an example of a simplified schematic of a satellite 200 that may be used in a satellite constellation in which satellites may communicate with one another over an OISL link. The satellite 200 includes a power source 210, which is often a battery pack with a solar panel power source, to supply, via a power distribution plane 215, the other components in the electronic system. As should be appreciated, an LEO satellite may spend a large portion of time eclipsed by the planet and may need to rely on battery power when direct solar power is not available.

As should be understood, FIG. 2 does not show all of the systems that may be on satellite 200, but some of the communication-related systems are depicted, including a compute and spacecraft management system 220, a clock source(s) 230, a satellite bus 240, a modem 250, additional modems 260 (e.g., a number of additional OISL modems), RF modem(s)/antenna(s) 270, and an optical head 280 (e.g., with an optical transceiver) connected to the modem 250 via one or more optical fibers/paths 290. As should be understood multiple components may be included in the satellite for redundancy reasons, so, for example, more than one OISL modem (e.g., modem 250 plus additional modems 260) may be included as a redundant OISL modem and/or to provide support for different OISL frequency bands. As should be understood, RF modem(s)/antenna(s) 270 may also be part of satellite 200, where these may be used for planetary links, such as to a ground station or to a user on Earth. The compute and spacecraft management system 220 may manage the guidance and stability functions of the spacecraft, and it may also control the power, thermal management, telemetry data of each of the modems.

The satellite bus 240 (also called a spacecraft bus) may include a data-plane packet switch within or adjacent to the compute and spacecraft management system 220 for managing routing of the data to the various modems operating on satellite 200. Also connected into the satellite bus 240 may be clock source(s) 230, which may be used by satellite 200 to accurately track its space position. Given the velocity with which satellite 200 may be traveling, highly accurate positioning in space may be important when communicating with other satellites. A satellite may travel 25,000 km/hr, which means it travels over 8 km/second, and a relative velocity between two satellites may be as high as 16.5 km/s. Thus, if the clocks on either satellite is incorrect—even slightly—then the satellite's PAT (pointing, acquisition, and tracking) of the OISL optical head system may not be able to communicate with other satellites, owing to an attempt to acquire a satellite at the wrong spatial location. In addition, clocks may be used to track and relay accurate time information for planetary terrestrial services such as geo-location.

As should be appreciated, while only one optical head 280 is depicted in FIG. 2, satellites often have more than one optical head, where four heads are normally installed on a single spacecraft. This provides for independent OISL links to multiple other satellites, allowing for the building of mesh networks. To build an OISL link, there are primarily two functional domains, namely the (i) an OISL modem (e.g., modem 250) and (ii) an optical head (e.g., optical head 280).

The optical head 280 may provide multiple functions, including optical telescope functions, gimbal (telescope pointing) functions, PAT (pointing acquisition and tracking) functions, optical low noise amplifier (LNA) functions for receive communication channels, OHPA (optical high-power amplifier) functions for amplifying transmit signals, optical filter functions to isolate transmit signals from receive signals and to isolate background solar radiation, beacon laser functions to support PAT functions, beacon sensors to support PAT functions, compute functions to support C2 interfaces, to process ephemeris information, to deduce gimbal pointing angles, and to perform doppler estimation. An optical lens 281 may provide a focal point for transmitted and received optical signals from/to the satellite 200.

The modem 250 may include optical to electrical circuits for the receive functions and, conversely, may include electrical to optical circuits for transmit functions. The modem 250 may include analog to digital (ADC) signal processing of the receive signals. The digital signal processing on the receive path performs filtering, channel equalization, doppler correction, demodulation, clock data recovery (CDR), de-framing, forward error correction (FEC) decoding followed by relaying data to the satellite bus-hosted compute systems. For the transmit path, the processing functions may include processing data payloads received from ethernet ports, FEC encoding, protocol framing, modulation formatting, filtering, optical/analog impairment corrections, digital to analog conversion (DAC), filtering, gain stages, optical modulators (e.g., a Mach-Zehnder modulator (MZM)), optical switches, and/or fiber coupling.

Satellite bus 240 may be the main body and structural component of satellite 200, in which the payload and all scientific instruments may be held. The satellite bus 240 may also contain the conduits for power (e.g., power distribution plane 215), data (e.g., data plane 225), and clocks to be distributed to supported modules.

The modem may also include laser functions to generate the carrier light signal to be modulated on the transmitter and, in receive mode, may include a receive (RX) local oscillator) laser source.

In the context of a satellite such as satellite 200, the disclosed optical coupling network and calibration may be used to determines the delay through optical head and through the interconnects to the modem function for both the transmit path and the receive path, individually. This allows for the delay calibration to be performed on ground (e.g., at the factory/during assembly) or after deployment (e.g., in mission mode operation such as after satellite 200 has been placed in orbit).

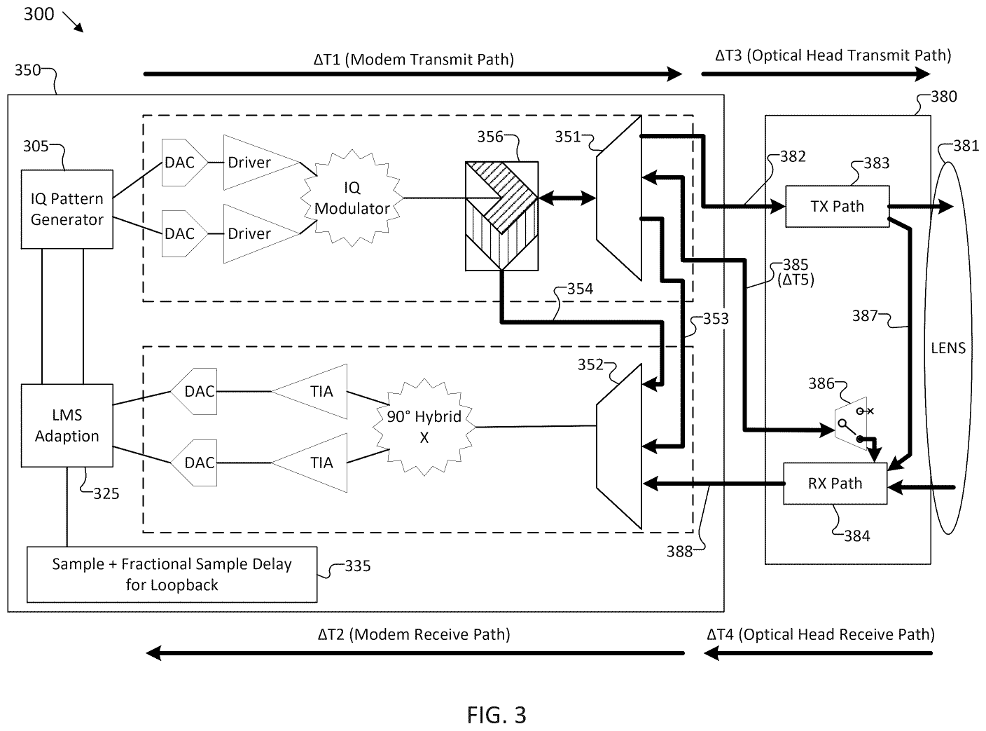

FIG. 3 shows a simplified graphic depiction of the optical coupling network that may be used for calibrating the delay through an optical head 380 and through the interconnects to modem 350 for both the transmit path and the receive path, individually. The optical coupling network may be operatively switched (e.g., through switches, selective couplers, selective filters, tuned Mach-Zehnder interferometer (MZI switches), micro-electromechanical systems (MEMS), etc. that may be selectively operated by a processor or by their active/passive nature) to establish and measure the delay of different loopback paths through various portions of the transmit path and receive path. When these measured portions are combined (e.g., using a set of difference equations), the calibration procedure may determine the signal propagation delays in the various paths through the optical head, through the interconnects, and through the modem on both the transmit side and the receive side, individually.

The optical coupling network may provide for a first loopback path/mode (LB1) that provides the time delay within the modem 350. In other words, LB1 may be the time for a round trip of the signal propagation from the modem logic (e.g., from pattern generator 305) through DACs, drivers, modulator, optical transmit path processing and then back through the receiver optical processing to photodiodes (PDs), a transimpedance amplifier (TIA), ADCs, and to digital logic (e.g., least mean squares (LMS) adaption 325) within the modem 350 to perform at least a temporal comparison of the signal originated at the input to the in-phase/quadrature (IQ) digital-to-analog converters (DACs) and the signal that is detected at the IQ analog-to-digital (ADC) outputs. To enable LB1, a coupler 351 on the transmitter side (e.g., a transmitter coupler) may be selected to couple, via modem loopback path 353, the modem transmit path to the modem receive path via a coupler 352 on the receiver side (e.g., a receiver coupler). By operating the optical coupling network to utilize the modem loopback path 353, satellite 300 may measure the round trip time delay (LB1) through both the transmit path (ΔT1 or the modem transmit path) and receive path (ΔT2 or the modem receive path) for the circuits/optical structures within the modem. Thus, LB1=ΔT1+ΔT2.

The optical coupling network may provide for a second loopback path/mode (LB2) that provides the time delay of the entire transceiver chain including the modem 350 and the optical head 380 on both the transmit side and receive side. In other words, this is the round trip delay from the modem logic through the modem transmit path (ΔT1) and the optical head transmit path (ΔT3) and back through the optical head receive path (ΔT4) and through the modem receive path (ΔT2). This loopback path may include, in the modem 350, for example, DACs, drivers, modulator, and optical transmit path processing in the modem 350. The path continues along a first fiber interconnect 382 from the modem 350 to the optical head 380.

In the optical head, the path may include an optical head transmit processing path 383 that includes, for example, optical fiber, an optical head amplifier (OHA), and other circuitry up to the output at lens 381. Then, the signal is looped back, via optical head loopback path 387, to the receiver side, starting with the optical head receive processing path 384, which may include filtering and an optical low noise amplifier (OLNA), and a second fiber interconnect 388 to the modem 350. In the modem 350, the modem receive path (ΔT2) may include modem optical receive processing, PDs, TIA, ADCs, and digital logic within modem 350. To enable LB2, the satellite 300 may operate coupler 351 to couple, via fiber interconnect 382, the modem transmit path to the optical head transmit path. The satellite 300 may also have/operate a loopback coupler(s) between the optical transmit path 383 and the optical receive path 384 to provide the optical head loopback path 387 between the optical transmit path 383 and the optical receive path 384. The satellite 300 may operate coupler 352 to connect the optical head loopback path 387 through the fiber interconnect 388 to the modem receive path and through the modem 350. Operating the optical coupling network to utilize the optical head loopback path 387 allows the satellite 300 to measure the round trip time delay (LB2) through the entire transmit path (modem transmit path, ΔT1, and optical head transmit path, ΔT3) together with the entire receive path (optical head receive path, ΔT4, and modem receive path, ΔT2). Thus, LB2=ΔT1+ΔT3+ΔT4+ΔT2.

The optical coupling network may provide for a third loopback path/mode (LB3), where the transmit is routed via coupler 351 from the modem transmit to a third fiber interconnect 385 that provides a calibration path (ΔT5) from the output of the modem transmit path to the input of the optical receiver of the optical head 380 (e.g., the optical receiver insertion point). At the end of fiber interconnect 385 (also referred to as calibration path 385), a calibration termination switch 386 may be operable to present the end of the fiber interconnect 385 with a return loss of close to 0 dB, which means that signals (or an attenuated version thereof) traveling through the fiber interconnect 385 to the calibration termination switch 386 are reflected back toward the modem transmit path of modem 350 (e.g., back toward coupler 351), where the signal may be routed via a modem loopback path 354 back to the modem receive path. At or as part of coupler 351, a direction coupler 356 may couple the signal reflected back through the interconnect 385 to the modem loopback path 354. As should be understood, the directivity of direction coupler 356 ensures that the signal on the outward path (from the start of the modem transmit path) is isolated from the reflected signal (reflected back from the calibration termination switch 386) so that the reflected signal (or an attenuated version thereof) may be routed to the modem loopback path 354. This function may be embodied as an MZI that is switched and tuned to detect the reflected signal. As should also be understood, while coupler 351 and directional coupler 356 are shown as two components, they may be understood as a single coupler that provides functions of both coupler 351 and directional coupler 356. The directional coupler 356 may be or include a Mach-Zehnder Interferometer (MZI) switch.

Operating the optical coupling network to utilize the calibration path 385 (ΔT5) allows the satellite 300 to measure the round trip time delay (LB3) that follows a path through the modem transmit path, ΔT1, twice through the calibration path 385, ΔT5, and through the modem receive path, ΔT2). Thus, LB3=ΔT1+2ΔT5+ΔT2.

As should be understood, calibration termination switch 386 may be a tunable filter, electro-optical switches including MZI-based switches or MEMS based switches, or any other type of optical component/open circuit that may selectively present a return loss of approximately 0 dB (e.g., an open circuit) to the end of the calibration path 385 at the receiver insertion point on the optical head 380. As will be discussed, calibration termination switch 386 may also provide a switching function that allows the satellite 300 to selectively present to the calibration path 385 either a return loss of approximately 0 dB (for LB3 mode to reflect the signal or a portion of the signal) or a coupling to the optical receive path 384 to feedback signals from the calibration path 385 through the receiver when in other loopback modes (e.g., LB4 discussed below).

The optical coupling network may provide for a fourth loopback path/mode (LB4), where the transmit is routed from the modem transmit path into the calibration path 385 and back through the input of the optical receive path 384 of the optical head 380. In LB4 mode, the satellite may operate calibration termination switch 386 located at the receiver insertion point on the optical head 380 to couple signals from the calibration path 385 to the input of the optical receive path 384. As should be appreciated, calibration termination switch 386 may be an optical switch (e.g., opened in LB3 mode to present approximately 0 dB insertion loss or closed in LB4 mode to pass the signal through to the optical receive path 384) or a filter with a tunable passband response located at a receiver insertion point on the optical head. Therefore, in LB4 mode, a calibration signal that originates on the transmit side of modem 350 may travel along a path that includes the modem transmit path, ΔT1, through the calibration path, ΔT5, through the optical head receive path, ΔT4, and through the modem receive path ΔT2. Thus, LB4=ΔT1+ΔT5+ΔT4+ΔT2.

Based on signal propagation time delays determined for each of these four loopback modes, the satellite 300 may determine a transmit time delay for the entire transmit path outside the modem (e.g., the optical head transmit path, ΔT3) as well as a receive time delay for the entire receive path outside the modem (e.g., the optical head receive path, ΔT4). This may be done by measuring the signal propagation time delay in each mode and then using the set of equations for each of the feedback loops to determine the transmitter time delay and the receiver time delay. As should be appreciated, this may be further adjusted to account for other contributions to the delay, such as well-defined, consistent delays in electronic components, fixed distances of optical waveguides on a photonics integrated circuit (PIC), etc.

Thus, based on the four paths/modes discussed above, LB1, LB2, LB3, and LB4, signal propagation time delays may be measured for each of the four modes/along each of the four paths, where each mode is represented by the following equations:

$$LB 1 = Δ T 1 + Δ T 2$$

$$LB 2 = Δ T 1 + Δ T 2 + Δ T 3 + Δ T 4$$

$$LB 3 = Δ T 2 + Δ T 1 + 2 Δ T 5$$

$$LB 4 = Δ T 2 + Δ T 1 + Δ T 4 + Δ T 5$$

The above equations may be solved for each of the time delays ΔT1, ΔT2, ΔT3, ΔT4, and ΔT5, and in particular to determine the transmit time delay (ΔT3) and the receive time delay (ΔT4), each of which may be expressed in terms of the measured loopback delays of LB1, LB2, LB3, LB3. For example, the delay of the calibration path 385 (ΔT5) may be determined based on LB1 and LB3, according to the following equation:

$$Δ T 5 = \frac{1}{2} ( LB 3 - LB 1 )$$

As another example, the delay of the optical head receive path (ΔT4) may be determined based on LB1, LB3, and LB4, according to the following equation:

$$Δ T 4 = LB 4 - LB 1 - Δ T 5 thus , Δ T 4 = LB 4 - \frac{1}{2} ( LB 1 + LB 3 )$$

As another example, the delay of the optical head transmit path (ΔT3) may be determined based on LB1, LB2, LB3, and LB4, according to the following equation:

$$Δ T 3 = LB 2 - LB 4 + \frac{1}{2} ( LB 3 - LB 1 )$$

As should be appreciated, the optical coupling network may be comprised of any number and type of switches, couplers, filters, fibers, etc. that enable selectively providing the loopback pathways, and those examples shown and described with respect to FIG. 3 are merely exemplary and non-limiting. For example, portions of the optical coupling network may be located in a photonics integrated circuit (PIC), where the optical coupling network comprises optical switches that may be selectively operated to provide different optical paths within the PIC, where the paths may exit/enter the PIC via edge couplers, grating couplers, or other types of optical ports.

As should also be appreciated, while FIG. 3 is shown and described with respect to a single transmit fiber (e.g., interconnect 382) and a single receive fiber (e.g., interconnect 388) for coupling the modem 350 to the optical head 380 to provide paths for signal communications, this may be scaled to additional loopback paths/modes in order to accommodate a case where additional fibers (e.g., additional fibers for transmitting/receiving different polarization modes) may couple the modem 350 to the optical head 380. Then, the system may use the measurements from the loopback modes, and based on the various difference equations, determine the relevant transmit and receive paths. It should also be appreciated that if a phase maintaining fiber—single mode fiber (PMF-SMF) is used, then the optical signal propagating parallel to the slow axis and that which is propagating along the fast access may have different propagation times.

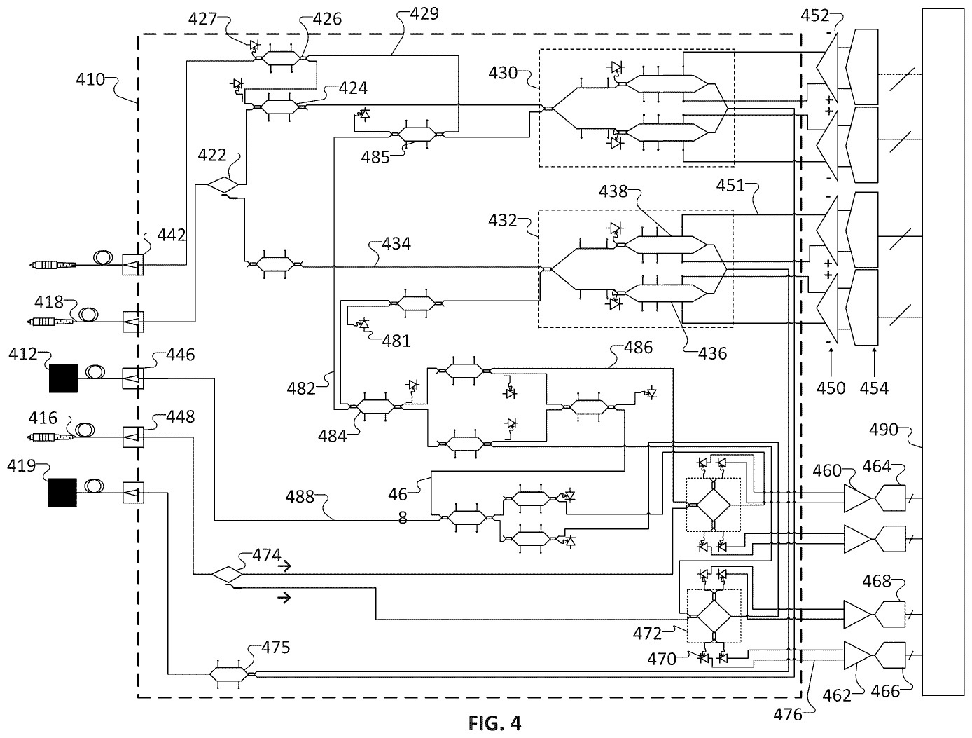

FIG. 4 shows an example schematic drawing of how the optical feedback network may be implement (at least in part) in a photonics integrated circuit. The photonics integrated circuit may utilize tunable switches (e.g., optical switches, MZI switches, filters, optical taps, etc.) to provide selectable couplings for the different calibration loopback pathways through modem and optical head. In particular, FIG. 4 shows the PIC 410 with edge couplers 448, 446 or 442, which may be edge couplers or grating couplers that allow interface to fiber connections. Lasers (e.g., TX laser 419 and RX laser 412) may be connected via fiber. As should be understood, the lasers may also be coupled die-to-die or through the implantation of ii-vi material such as indium phosphide to a silicon photonics process to allow an efficient laser source. The RX fiber 416 input from the optical head, the calibration path 414, and the TX fiber 418 are provisioned.

The TX laser 419 may be optionally optically power split 475 and input to MZM modulators 430, 432. The modulator output may be input to a thermally controlled MZI switch 424 as part of the transmit coupler structure to selectively couple to calibration path 414 through MZI 426 or on transmit path through polarization beam combiner 422, the output of which may be waveguide connected to the optical port and transmit fiber 418.

The modem DSP (digital signal processing) 490 provides digital signals for transmission or used for calibration to DACs (e.g. DACs 454), where the DAC output signals may be amplified via driver amplifiers (for example amplifiers 452, 450). The DACs may drive MZM based IQ modulators (e.g., modulators 436, 438) to generate an optical modulated signal.

In the receive path processing, signals on fiber 416 may be coupled through edge coupler 448 to a polarization beam splitter 474, which functions to pass TE (transverse electric) mode signals through and rotates TM (transverse magnetic) to TE mode, the output of which may be sent to a pair of 90° 3 dB hybrid couplers (e.g. pair 472) where the local laser signal may originate in from laser 412 and may be coupled on chip via edge coupler 446. This signal may be subsequently split at each of the 3 dB hybrid couplers (e.g., pair 472). The output of each 3 dB hybrid coupler (e.g. pair 472) may generate signals (e.g., receive I and Q differential optical signals) which may be detected using a differential pair of photodiodes (PDs) (e.g. PD 470). The PD outputs may be input electrical signals (e.g. 476) that are then input to TIAs (e.g. 462, 460). The TIA out signals may be input to respective ADCs (e.g. 464, 468, 466) and the signals then provided to the modem DSP (digital signal processing) 490 for subsequent processing, including, for example, demodulation or for the purposes described herein with respect to calibration of the signal propagation delays through various paths.

Referring again to FIG. 4 and in particular to the calibration path through MZI 426, this MZI may be tuned thermally via resistive heaters co-located that may change the local temperature and, in doing so, may change the refractive index of a waveguide. In doing so, this may tune the wavelength of operation as well as the direction of signal propagation. This may also tune the signal propagation flow for signals in either direction. For example, this signal input to the MZI port connected to MZI 424 may have 80% of the power at its output directed to the edge coupler 441 and the calibration path 414 and the remaining 20% of its output power would be directed to the monitoring PD 427. This construct may also operate in such a way that any reflected power or input power on the calibration path 414 may be split in a similar ratio with 80% of the power on path 429 and 20% back to the transmitter selecting MZI 424. The signal on wave guide may be selected to on MZI 485 to pass to MZI 484 and successively to waveguide 486 as an input to an 90° hybrid coupler (e.g. 472) and be processed as described above.

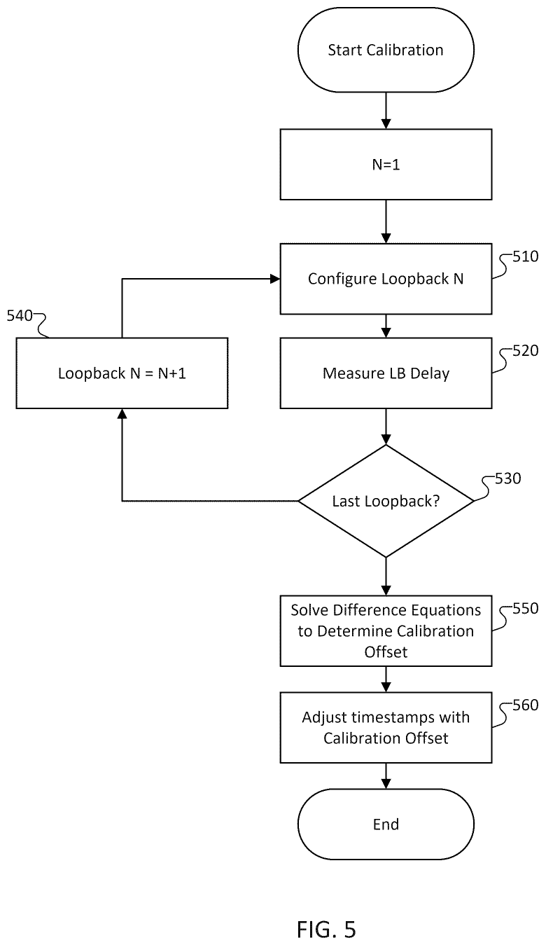

FIG. 5 shows an algorithm flowchart of a calibration process that uses an optical coupling network to make loopback measurements in order to determine a signal propagation time delay calibration for transmit and receive paths of a combination of modem and optical head, as discussed above, in for example, a satellite.

At the start of the calibration, the system configures the optical coupling network for the first (N=1) loopback path/mode, in 510 (e.g., a processor operating/selecting the paths through the various couplers/switches/filters to create the desired loopback path). After configuring the optical coupling network to loopback N, the system measures, in 520, the time delay of the configured loopback (LB) path (e.g., by transmitting a calibration signal through the configured portion of the modem transmitter, optical loopback path, and modem receiver). The system may then determine, in 530, whether all of the needed loopbacks have been measured, and if not, increments, in 540, to the next loopback path (N=N+1), configures the optical coupling network, in 510, to the new loopback N path, and measures, in 520, the associated LB delay for the configured loopback N path.

Once the time delays for all of the loopback paths have been measured, the difference equations are solved, in 550, to determine the relevant calibration time delay(s) (or calibration offset(s)) based on the measured delays of the loopback paths. Next, the system updates, in 560, its timestamps to include the calibration offset(s), which may be different/independent for the transmit path and the receive path. As should be understood, the system may receive real-time clock information from another satellite for updating its clock to a local reference. The system may use the calibration offset(s) to adjust the received time stamp information (e.g., subtract the time of receiver path processing within the modem to adjust local clocks). The system may also use the time-of-flight calculated based on the ephemeris information of both satellites for this local clock adjustment.

Conversely, if the modem transmits time information, this time information relayed may be adjusted to take into account processing delays through the modem and the optical head transmit paths.

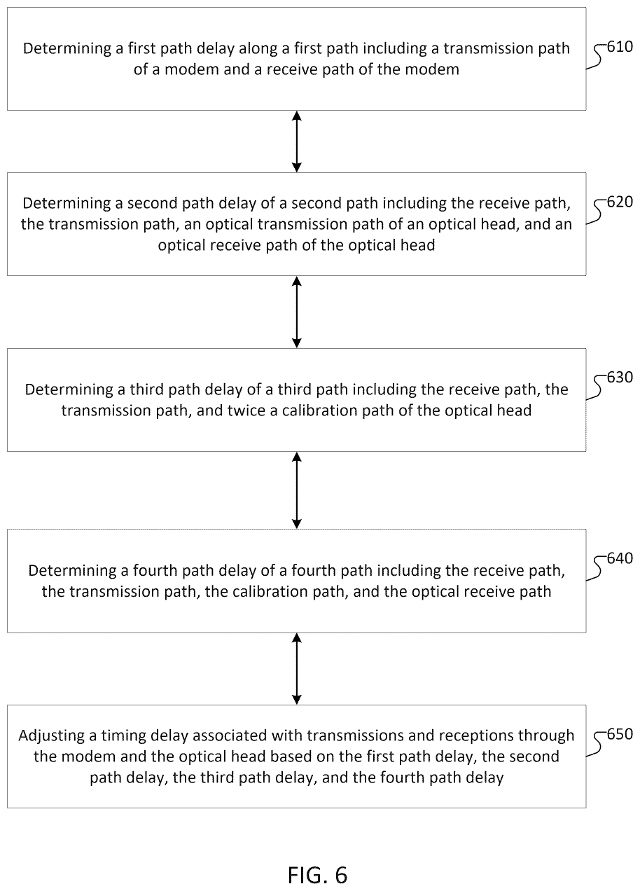

FIG. 6 depicts a schematic flow diagram of a method 600 for determining a calibration delay using an optical coupling network to select different loopbacks. Method 600 may implement any of the features discussed above with respect to using an optical coupling network for calibrating delays. Method 600 includes, in 610, determining a first path delay along a first path including a transmission path of a modem and a receive path of the modem. Method 600 also includes, in 620, determining a second path delay of a second path including the receive path, the transmission path, an optical transmission path of an optical head, and an optical receive path of the optical head. Method 600 also includes, in 630, determining a third path delay of a third path including the receive path, the transmission path, and twice a calibration path of the optical head. Method 600 also includes, in 640, determining a fourth path delay of a fourth path including the receive path, the transmission path, the calibration path, and the optical receive path. Method 600 also includes, in 650, adjusting a timing delay associated with transmissions and receptions through the modem and the optical head based on the first path delay, the second path delay, the third path delay, and the fourth path delay.

In the following, various examples are provided that may include one or more features of the contactless coupler and waveguide interconnect discussed above. It may be intended that aspects described in relation to the devices may apply also to the described method(s), and vice versa.

Example 1 is a device including a modem including a modem transmit path and a modem receive path. The device also includes an optical head including an optical transmit path, an optical receive path, and a calibration path. The device also includes a receiver coupler couplable to the modem receive path. The device also includes a transmitter coupler couplable to the modem transmit path and configurable to selectively couple the modem transmit path to the optical transmit path, the calibration path, or a modem loopback path (e.g., for forward signals to loopback from the modem transmit path to the modem receive path or in a reverse direction to loopback reflected signals from the calibration path to the modem receive path), wherein the receiver coupler is configurable to selectively couple the modem receive path to the optical receive path or to the modem loopback path. The device also includes a loopback coupler configurable to selectively couple the optical transmit path to the optical receive path. The device also includes a calibration termination switch coupled to the calibration path and configurable to selectively reflect signals (e.g., a calibration signal) back to the transmitter coupler (e.g., back along the calibration path) or pass signals through to the optical receive path (e.g., to an input of the optical receive path).

Example 2 is the device of example 1, the device further including a processor configured to selectively operate the receiver coupler, the transmitter coupler, the loopback coupler, and the calibration termination switch as an optical feedback network in a first mode, a second mode, a third mode, or a fourth mode to loopback signals through the modem transmit path and back through the modem receive path. The processor is further configured to measure a first time delay when the optical feedback network is in the first mode, wherein in the first mode: the transmitter coupler couples the modem transmit path to the modem loopback path; and the receiver coupler couples the modem receive path to the modem loopback path. The processor is further configured to measure a second time delay when the optical feedback network is in the second mode, wherein in the second mode: the transmitter coupler couples the modem transmit path to the optical transmit path; the loopback coupler couples the optical transmit path to the optical receive path; and the receiver coupler couples the optical receive path coupled to the modem receive path. The processor is further configured to measure a third time delay when the optical feedback network is in the third mode, wherein in the third mode: the transmitter coupler couples the modem transmit path to the calibration path; the receiver coupler couples the modem loopback path to the modem receive path; the calibration termination switch reflects the signals back to the transmitter coupler; and the transmit coupler couples the reflected signals to the modem loopback path (e.g., via a directional coupler of the transmitter coupler). The processor is further configured to determine a fourth time delay, when the optical feedback network is in the fourth mode, wherein in the fourth mode: the transmitter coupler is configured to couple the modem transmit path to the calibration path; the calibration termination switch couples the calibration path to the optical receive path; and the receiver coupler couples the optical receive path to the modem receive path.

Example 3 is the device of example 2, wherein the processor is configured to determine a transmit path timing delay (e.g., a signal propagation delay time) through the optical transmit path based on the first time delay, the second time delay, the third time delay, and the fourth time delay. The processor is further configured to determine a receive path timing delay (e.g., a signal propagation delay time) through the optical receive path based on the first time delay, the second time delay, the third time delay, and the fourth time delay.

Example 4 is the device of any one of examples 2 to 3, wherein each of the first, second, third, and fourth time delays are a signal propagation time for a calibration signal that originates at a start point in the modem transmit path and propagates to a termination point in the modem receive path after being routed through the optical feedback network.

Example 5 is the device of any one of examples 1 to 4, wherein the calibration termination switch is located at a receiver insertion point on the optical head.

Example 6 is the device of any one of examples 1 to 5, wherein the modem loopback path includes a first directional loopback path (e.g., for forward signals from the modem transmit path) (e.g., a forward loopback path) and a second directional loopback path (e.g., for reflected signals from calibration path) (e.g., a reverse/reflected loopback path).

Example 7 is the device of example 6, wherein the transmitter coupler includes a directional coupler (e.g., one or more Mach-Zehnder Interferometer (MZI) switches) that passes signals (e.g. forward signals) received from the modem transmit path and that couples signals (e.g., reflected signals) received from the calibration path to the second directional loopback path.

Example 8 is the device of any one of examples 1 to 7, wherein the optical head further includes an optical aperture at an optical output of the optical transmit path and at an optical input of the optical receive path.

Example 9 is the device of any one of examples 1 to 8, wherein the device includes a satellite system configured to apply a timestamp to optical communications with other satellite systems based on a time delay calibration using the modem transmit path, the optical transmit path, the optical receive path, the calibration path, the modem loopback path, and the modem receive path.

Example 10 is the device of any one of examples 1 to 9, further including a processor configured to perform a time calibration, wherein the time calibration includes the processor configured to determine a first time delay of a first path including the modem transmit path and the modem receive path. The time calibration further includes the processor configured to determine a second time delay of a second path including the modem receive path, the modem transmit path, the optical transmit path, and the optical receive path. The time calibration further includes the processor configured to determine a third time delay of a third path including the modem receive path, the modem transmit path, and twice the calibration path. The time calibration further includes the processor configured to determine a fourth path delay of a fourth path including the modem receive path, the modem transmit path, the calibration path, and the optical receive path.

Example 11 is the device of example 10, wherein the processor is further configured to operate the transmitter coupler, receiver coupler, loopback coupler, and the calibration termination switch to selectively route a calibration signal through the first path, second path, third path, and fourth path.

Example 12 is an apparatus including a modem including a modem transmit path and a modem receive path. The apparatus further includes an optical head including an optical transmit path, an optical receive path, and a calibration path. The apparatus further includes an optical coupling network configurable to selectively route a calibration signal: through a first loopback path including the modem transmit path and the modem receive path; through a second loopback path including the modem transmit path, the optical transmit path, the optical receive path, and the modem receive path; through a third loopback path including the modem transmit path, twice the calibration path, and the modem receive path; and through a fourth loopback path including the modem transmit path, the calibration path, the optical receive path, and the modem receive path.

Example 13 is the apparatus of example 12, wherein the optical coupling network includes a receiver coupler couplable to the modem receive path and, when the optical coupling network is configured to route the calibration signal through the first loopback path, the receiver coupler couples the modem receive path to a modem loopback path that is coupled to the modem transmit path.

Example 14 is the apparatus of example 13, wherein when the optical coupling network is configured to route the calibration signal through the second loopback path, the receiver coupler couples the optical receive path to the modem receive path.

Example 15 is the apparatus of any one of examples 13 to 14, wherein when the optical coupling network is configured to route the calibration signal through the third loopback path, the receiver coupler couples the modem receive path to the modem loopback path that is coupled to the calibration path (e.g., so that when the calibration reflects is reflected back, it travels through the modem loopback path and through the modem receive path).

Example 16 is the apparatus of any one of examples 13 to 15, wherein when the optical coupling network is configured to route the calibration signal through the fourth loopback path, the receiver coupler couples the optical receive path to the modem receive path.

Example 17 is the apparatus of any one of examples 12 to 16, wherein the optical coupling network includes a transmitter coupler couplable to the modem transmit path and, when the optical coupling network is configured to route the calibration signal through the first loopback path, the transmitter coupler couples the modem transmit path to a modem loopback path that is coupled to the modem receive path.

Example 18 is the apparatus of example 17, wherein when the optical coupling network is configured to route the calibration signal through the second loopback path, the transmitter coupler couples the modem transmit path to the optical transmit path.

Example 19 is the apparatus of any one of examples 17 to 18, wherein when the optical coupling network is configured to route the calibration signal through the third loopback path, the transmitter coupler couples the modem transmit path to the calibration path and a modem loopback path that is coupled to the modem receive path.

Example 20 is the apparatus of any one of examples 17 to 19, wherein when the optical coupling network is configured to route the calibration signal through the fourth loopback path, the transmitter coupler couples the modem transmit path to the calibration path.

Example 21 is the apparatus of any one of examples 12 to 20, wherein the optical coupling network includes a loopback coupler, wherein when the optical coupling network is configured to route the calibration signal through the second loopback path, the loopback coupler couples the optical transmit path to the optical receive path.

Example 22 is the apparatus of any one of examples 12 to 21, wherein the optical coupling network includes a calibration termination switch coupled to the calibration path, wherein when the optical coupling network is configured to route the calibration signal through the third loopback path, the calibration termination switch reflects the signals back through the calibration path.

Example 23 is the apparatus of example 22, wherein when the optical coupling network is configured to route the calibration signal through the fourth loopback path, the calibration termination switch couples the calibration path to (e.g., an input of) the optical receive path.

Example 24 is a method including determining a first path delay along a first path including a transmission path of a modem and a receive path of the modem. The method also includes determining a second path delay of a second path including the receive path, the transmission path, an optical transmission path of an optical head, and an optical receive path of the optical head. The method also includes determining a third path delay of a third path including the receive path, the transmission path, and twice a calibration path of the optical head. The method also includes determining a fourth path delay of a fourth path including the receive path, the transmission path, the calibration path, and the optical receive path. The method also includes adjusting a timing delay associated with transmissions and receptions through the modem and the optical head based on the first path delay, the second path delay, the third path delay, and the fourth path delay.

Example 25 is the method of example 24, wherein the timing delay includes a transmitter timing delay (e.g., a signal propagation time delay through the transmit path) and a receiver timing delay (e.g., a signal propagation time delay through the receive path) that is different from the transmitter timing delay.

Example 26 is the method of example 25, wherein the transmitter timing delay is associated with the transmissions through the optical head, wherein the receiver timing delay is associated with the receptions though the optical head.

Example 27 is the method of any one of examples 25 to 26, wherein the transmitter timing delay is associated with the transmissions along an optical transmission path through the optical head, wherein the receiver timing delay is associated with the receptions along an optical reception path through the optical head.

Example 28 is the method of any one of examples 24 to 27, wherein the timing delay includes a transmitter timing delay associated with the transmissions along an optical transmission path through the optical head, wherein the transmitter timing delay includes the second path delay minus the fourth path delay plus one-half of the third path delay minus one-half of the first path delay.

Example 29 is the method of any one of examples 24 to 28, wherein the timing delay includes a receiver timing delay associated with the receptions along an optical reception path through the optical head, wherein the receiver timing delay includes the fourth path delay minus one-half of the third path delay minus one-half of the first path delay.

Example 30 is the method of any one of examples 24 to 29, wherein determining the first, second, third, and fourth path delay includes routing a calibration signal along a respective one of the first path, second path, third path, and forth path.

Example 31 is the method of any one of examples 24 to 30, wherein determining the first, second, third, and fourth path delay includes a propagation time of a signal routed through a respective one of the first path, second path, third path, and forth path.

Example 32 is a device including a means for communicating (e.g., a modem) that includes a transmit path and a receive path. The device also includes a means for optical communications (e.g., an optical head with an optical transceiver) that includes an optical transmit path, an optical receive path, and a calibration path. The device also includes a means for selectively coupling (e.g., via switches) to the receive path. The device also includes a means for selectively coupling (e.g., via switches) the transmit path to the optical transmit path, the calibration path, or a loopback path (e.g., for forward signals to loopback from the transmit path to the receive path or in a reverse direction to loopback reflected signals from the calibration path to the receive path). The device also includes a means for selectively coupling the optical transmit path to the optical receive path. The device also includes, on the calibration path, a means for selectively reflecting a calibration signal back to the means for coupling to the transmit path (e.g., back along the calibration path) or passing the calibration signal through to the optical receive path (e.g., to an input of the optical receive path) (e.g. a termination switch).

Example 33 is the device of example 32, the device further including a means for selectively operating the means for coupling to the receive path, the means for coupling to the transmit path, the means for selectively coupling the optical transmit path to the optical receive path, and the means for selectively reflecting the calibration signal back to the means for coupling to the transmit path (e.g., collectively, an optical feedback network) in a first mode, a second mode, a third mode, or a fourth mode to loopback the calibration signal originating at a point in the receive path back to a termination point in the receive path. The device further includes a means for measuring a first time delay (e.g., a signal propagation time from the point in the receive path through the optical feedback network to the termination point) when the optical feedback network is in the first mode, wherein in the first mode: the means for selectively coupling to the transmit path couples the transmit path to the loopback path; and the means for selectively coupling to the receive path couples the receive path to the loopback path. The device further includes a means for measuring a second time delay when the optical feedback network is in the second mode, wherein in the second mode: the means for selectively coupling to the transmit path couples the transmit path to the optical transmit path; the means for selectively coupling the optical transmit path to the optical receive path couples the optical transmit path to the optical receive path; and the means for selectively coupling to the receive path couples the optical receive path to the receive path. The device further includes a means for measuring a third time delay when the optical feedback network is in the third mode, wherein in the third mode: the means for selectively coupling to the transmit path is configured to couple the transmit path to the calibration path; the means for selectively coupling to the receive path couples the loopback path to the receive path; and the means for selectively reflecting or passing the calibration signal reflects the calibration signal back along the calibration path to the means for selectively coupling to the transmit path and through the loopback path. The device further includes a means for measuring a fourth time delay, when the optical feedback network is in the fourth mode, wherein in the fourth mode: the means for selectively coupling to the transmit path is configured to couple the transmit path to the calibration path; the means for selectively coupling to the receive path couples the optical receive path to the receive path; and the means for selectively reflecting or passing the calibration signal passes the calibration signal from the calibration path onward to the optical receive path.

Example 34 is the device of example 33, wherein the device is further includes a means for determining a transmit path timing delay through the transmit path and the optical transmit path based on the first time delay, the second time delay, the third time delay, and the fourth time delay. The device further includes a means for determining a receive path timing delay through the optical receive path and the transmit path based on the first time delay, the second time delay, the third time delay, and the fourth time delay.

Example 35 is the device of any one of examples 32 to 34, wherein the means for selectively reflecting or passing the calibration signal includes a termination switch.

Example 36 is the device of any one of examples 32 to 35, wherein the means for selectively reflecting or passing the calibration signal is located at a receiver insertion point at the optical receive path on the means for optical communications.

Example 37 is the device of any one of examples 32 to 36, wherein the loopback path includes a first directional loopback path (e.g., for forward signals from the transmit path) and a second directional loopback path (e.g., for reflected signals from calibration path).

Example 38 is the device of example 37, wherein the means for selectively coupling to the transmit path includes a means for directionally coupling to selectively pass the calibration signal (e.g. forward signals) in a forward direction from the transmit path or pass the calibration signal (e.g., reflected signals) when reflected in a reverse direction from the calibration path to the second directional loopback path.

Example 39 is the device of any one of examples 32 to 38, wherein the means for optical communications further includes an optical aperture and an optical transceiver.

Example 40 is the device of any one of examples 32 to 39, wherein the device includes a means for applying a timestamp to optical communications based on a time delay calibration using the transmit path, the optical transmit path, the optical receive path, the calibration path, the loopback path, and the receive path.

Example 41 is the device of any one of examples 32 to 40, further including a means for performing a time calibration, wherein the time calibration includes a means for determining a first time delay of a first path including the transmit path and the receive path. The time calibration further includes means for determining a second time delay of a second path including the receive path, the transmit path, the optical transmit path, and the optical receive path. The time calibration further includes a means for determining a third time delay of a third path including the receive path, the transmit path, and twice the calibration path. The time calibration further includes a means for determining a fourth path delay of a fourth path including the receive path, the transmit path, the calibration path, and the optical receive path.

Example 42 is the device of example 41, further includes a means for operating the means for selectively coupling to the transmit path, the means for selectively coupling to the receive path, the means for selectively coupling the optical transmit path to the optical receive path, and the means for selectively reflecting or passing in order to selectively route the calibration signal through the first path, second path, third path, and fourth path.

Example 43 is an apparatus including a means for communication (e.g., for analog to digital communication, e.g., a modem) including a transmit path and a receive path. The apparatus further includes a means for optical communication (e.g., an optical head) including an optical transmit path, an optical receive path, and a calibration path. The apparatus further includes a means for optically coupling to selectively route a calibration signal: through a first loopback path including the transmit path and the receive path; through a second loopback path including the transmit path, the optical transmit path, the optical receive path, and the receive path; through a third loopback path including the transmit path, twice the calibration path, and the receive path; and through a fourth loopback path including the transmit path, the calibration path, the optical receive path, and the receive path.

Example 44 is the apparatus of example 43, wherein the means for optically coupling includes a means for selectively coupling to the receive path and, when the means for optically coupling is configured to route the calibration signal through the first loopback path, the means for selectively coupling to the receive path couples the receive path to a loopback path that is coupled to the transmit path.

Example 45 is the apparatus of example 44, wherein when the means for optically coupling is configured to route the calibration signal through the second loopback path, the means for selectively coupling to the receive path couples the optical receive path to the receive path.

Example 46 is the apparatus of any one of examples 44 to 45, wherein when the means for optically coupling is configured to route the calibration signal through the third loopback path, the means for selectively coupling to the receive path couples the receive path to the loopback path that is coupled to the calibration path.

Example 47 is the apparatus of any one of examples 44 to 46, wherein when the means for optically coupling is configured to route the calibration signal through the fourth loopback path, the means for coupling to the receive path couples the optical receive path to the receive path.

Example 48 is the apparatus of any one of examples 43 to 47, wherein the means for optically coupling includes a means for selectively coupling to the transmit path, wherein when the means for optically coupling is configured to route the calibration signal through the first loopback path, the means for selectively coupling to the transmit path couples the transmit path to the receive path.

Example 49 is the apparatus of example 48, wherein when the means for optically coupling is configured to route the calibration signal through the second loopback path, the means for selectively coupling to the transmit path couples the transmit path to the optical transmit path.

Example 50 is the apparatus of any one of examples 48 to 49, wherein when the means for optically coupling is configured to route the calibration signal through the third loopback path, the means for selectively coupling to the transmit path couples the transmit path to the calibration path that is coupled to the receive path.

Example 51 is the apparatus of any one of examples 48 to 50, wherein when the means for optically coupling is configured to route the calibration signal through the fourth loopback path, the means for selectively coupling to the transmit path couples the transmit path to the calibration path that is coupled to the optical receive path.

Example 52 is the apparatus of any one of examples 43 to 51, wherein the means for optically coupling includes a means for coupling the optical transmit path to the optical receive path, wherein when the means for optically coupling is configured to route the calibration signal through the second loopback path, the means for coupling the optical transmit path to the optical receive path couples the optical transmit path to the optical receive path.

Example 53 is the apparatus of any one of examples 43 to 52, wherein the means for optically coupling includes a means for selectively reflecting the calibration signal back through the calibration path or passing the calibration to the optical receive path, wherein when the means for optically coupling is configured to route the calibration signal through the third loopback path, the means for selectively reflecting the calibration signal back through the calibration path or passing the calibration to the optical receive path reflects the calibration signal back through the calibration path.

Example 54 is the apparatus of example 53, wherein when the means for optically coupling is configured to route the calibration signal through the fourth loopback path, the means selectively reflecting the calibration signal back along the calibration path or passing the calibration to the optical receive path passes the calibration signal to the optical receive path.

Example 55 is a device including a means for determining a first path delay along a first path including a transmission path (e.g., of a modem) and a receive path (e.g., of the modem). The device also includes a means for determining a second path delay of a second path including the receive path, the transmission path, an optical transmission path (e.g., of an optical head), and an optical receive path (e.g., of the optical head). The device also includes a means for determining a third path delay of a third path including the receive path, the transmission path, and twice a calibration path (e.g., of the optical head). The device also includes a means for determining a fourth path delay of a fourth path including the receive path, the transmission path, the calibration path, and the optical receive path. The device also includes a means for adjusting a timing delay associated with transmissions and receptions through the device based on the first path delay, the second path delay, the third path delay, and the fourth path delay.

Example 56 is the device of example 55, wherein the timing delay includes a transmitter timing delay and a receiver transmitter timing delay that is different from the transmitter timing delay.

Example 57 is the device of example 56, wherein the transmitter timing delay is associated with the transmissions through the device, wherein the receiver timing delay is associated with the receptions though the device.

Example 58 is the device of any one of examples 56 to 57, wherein the transmitter timing delay is associated with the transmissions through the optical transmission path, wherein the receiver timing delay is associated with the receptions through the optical receive path.

Example 59 is the device of any one of examples 55 to 58, wherein the timing delay includes a transmitter timing delay associated with the transmissions through the optical transmission path, wherein the transmitter timing delay includes the second path delay minus the fourth path delay plus one-half of the third path delay minus one-half of the first path delay.

Example 60 is the device of any one of examples 55 to 59, wherein the timing delay includes a receiver timing delay associated with the receptions through the optical receive path, wherein the receiver timing delay includes the fourth path delay minus one-half of the third path delay minus one-half of the first path delay.

Example 61 is the device of any one of examples 55 to 60, wherein the means for determining the first, second, third, and fourth path delay includes a means for routing the calibration signal along a respective one of the first path, second path, third path, and forth path.

Example 62 is the device of any one of examples 55 to 61, wherein the means for determining the first, second, third, and fourth path delay includes a propagation time of the calibration signal routed through a respective one of the first path, second path, third path, and forth path.

Example 63 is a non-transitory, computer-readable medium including instructions that, when executed, cause one or more processors to determine a first path delay along a first path including a transmission path of a modem and a receive path of the modem. The instructions also cause the one or more processors to determine a second path delay of a second path including the receive path, the transmission path, an optical transmission path of an optical head, and an optical receive path of the optical head. The instructions also cause the one or more processors to determine a third path delay of a third path including the receive path, the transmission path, and twice a calibration path of the optical head. The instructions also cause the one or more processors to determine a fourth path delay of a fourth path including the receive path, the transmission path, the calibration path, and the optical receive path. The instructions also cause the one or more processors to adjust a timing delay associated with transmissions and receptions through the optical head based on the first path delay, the second path delay, the third path delay, and the fourth path delay.

Example 64 is the non-transitory, computer-readable medium of example 63, wherein the timing delay includes a transmitter timing delay and a receiver transmitter timing delay that is different from the transmitter timing delay.

Example 65 is the non-transitory, computer-readable medium of example 64, wherein the transmitter timing delay is of the transmissions through the optical transmission path, wherein the receiver timing delay is of the receptions though the optical receive path.

Example 66 is the non-transitory, computer-readable medium of any one of examples 63 to 65, wherein the timing delay includes a transmitter timing delay of the transmissions through the optical transmit path, wherein the transmitter timing delay includes the second path delay minus the fourth path delay plus one-half of the third path delay plus one-half of the first path delay.

Example 67 is the non-transitory, computer-readable medium of any one of examples 63 to 66, wherein the timing delay includes a receiver timing delay of the receptions through the optical receive path, wherein the receiver timing delay includes the fourth path delay minus one-half of the third path delay minus one-half of the first path delay.

Example 68 is the non-transitory, computer-readable medium of any one of examples 63 to 67, wherein the instructions that cause the one or more processors to determine the first, second, third, and fourth path delay includes that the instructions also cause the one or more processors to route the calibration signal along a respective one of the first path, second path, third path, and forth path.

Example 69 is the non-transitory, computer-readable medium of any one of examples 63 to 68, wherein the instructions that cause the one or more processors to determine the first, second, third, and fourth path delay includes that the instructions also cause the one or more processors to determine a propagation time of the calibration signal routed through a respective one of the first path, second path, third path, and forth path.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A device comprising:
a modem comprising a modem transmit path and a modem receive path;
an optical head comprising an optical transmit path, an optical receive path, and a calibration path;
a receiver coupler couplable to the modem receive path;
a transmitter coupler couplable to the modem transmit path and configurable to selectively couple the modem transmit path to the optical transmit path, the calibration path, or a modem loopback path, wherein the receiver coupler is configurable to selectively couple the modem receive path to the optical receive path or to the modem loopback path; and
a loopback coupler configurable to selectively couple the optical transmit path to the optical receive path; and
a calibration termination switch configurable to selectively couple the calibration path to the optical receive path or reflect back to the transmitter coupler.

2. The device of claim 1, the device further comprising a processor configured to:
selectively operate the receiver coupler, the transmitter coupler, the loopback coupler, and the calibration termination switch as an optical feedback network in a first mode, a second mode, a third mode, or a fourth mode to loopback a calibration signal through the modem transmit path, the optical feedback network, and the modem receive path.

3. The device of claim 2, wherein the processor is further configured to:
measure a first time delay when the optical feedback network is in the first mode, wherein in the first mode: the transmitter coupler couples the modem transmit path to the modem loopback path; and the receiver coupler couples the modem receive path to the modem loopback path;
measure a second time delay when the optical feedback network is in the second mode, wherein in the second mode: the transmitter coupler couples the modem transmit path to the optical transmit path; the loopback coupler couples the optical transmit path to the optical receive path; and the receiver coupler couples the optical receive path coupled to the modem receive path;
measure a third time delay when the optical feedback network is in the third mode, wherein in the third mode: the transmitter coupler couples the modem transmit path to the calibration path; the receiver coupler couples the modem loopback path to the modem receive path; and the calibration termination switch reflects the calibration signal back to the transmitter coupler and through the modem loopback path; and
determine a fourth time delay, when the optical feedback network is in the fourth mode, wherein in the fourth mode: the transmitter coupler is configured to couple the modem transmit path to the calibration path; the calibration termination switch couples the calibration path to the optical receive path; and the receiver coupler couples the optical receive path to the modem receive path; and the calibration termination switch passes the calibration signal onward to the optical receive path.

4. The device of claim 3, wherein the processor is configured to:
determine a transmit path timing delay through the optical transmit path based on the first time delay, the second time delay, the third time delay, and the fourth time delay; and
determine a receive path timing delay through the optical receive path based on the first time delay, the second time delay, the third time delay, and the fourth time delay.

5. The device of claim 1, wherein the calibration termination switch is located at a receiver insertion point on the optical head.

6. The device of claim 1, wherein the modem loopback path comprises a first directional loopback path and a second directional loopback path.

7. The device of claim 6, wherein the transmitter coupler comprises a directional coupler that passes forward signals received from the modem transmit path and that couples reflected signals received back from the calibration path to the second directional loopback path.

8. The device of claim 1, wherein the device comprises a satellite system configured to apply a timestamp to optical communications with other satellite systems based on a time delay calibration using the modem transmit path, the optical transmit path, the optical receive path, the calibration path, the modem loopback path, and the modem receive path.

9. The device of claim 1, further comprising a processor configured to perform a time calibration, wherein the time calibration comprises the processor configured to:
determine a first time delay of a first path comprising the modem transmit path and the modem receive path;
determine a second time delay of a second path comprising the modem receive path, the modem transmit path, the optical transmit path, and the optical receive path;
determine a third time delay of a third path comprising the modem receive path, the modem transmit path, and twice the calibration path; and
determine a fourth path delay of a fourth path comprising the modem receive path, the modem transmit path, the calibration path, and the optical receive path.

10. The device of claim 9, wherein the processor is further configured to operate the transmitter coupler, receiver coupler, loopback coupler, and the calibration termination switch to selectively route a calibration signal through the first path, second path, third path, and fourth path.

11. An apparatus comprising:
a modem comprising a modem transmit path and a modem receive path;
an optical head comprising an optical transmit path, an optical receive path, and a calibration path; and
an optical coupling network configurable to selectively route a calibration signal:
through a first loopback path comprising the modem transmit path and the modem receive path;
through a second loopback path comprising the modem transmit path, the optical transmit path, the optical receive path, and the modem receive path;
through a third loopback path comprising the modem transmit path, twice the calibration path, and the modem receive path; and
through a fourth loopback path comprising the modem transmit path, the calibration path, the optical receive path, and the modem receive path.

12. The apparatus of claim 11, wherein the optical coupling network comprises a receiver coupler couplable to the modem receive path and, when the optical coupling network is configured to route the calibration signal through the first loopback path, the receiver coupler couples the modem receive path to a modem loopback path that is coupled to the modem transmit path.

13. The apparatus of claim 12, wherein when the optical coupling network is configured to route the calibration signal through the second loopback path, the receiver coupler couples the optical receive path to the modem receive path.

14. The apparatus of claim 12, wherein when the optical coupling network is configured to route the calibration signal through the third loopback path, the receiver coupler couples the modem receive path to the modem loopback path that is coupled to the calibration path.

15. The apparatus of claim 12, wherein when the optical coupling network is configured to route the calibration signal through the fourth loopback path, the receiver coupler couples the optical receive path to the modem receive path.

16. The apparatus of claim 11, wherein the optical coupling network comprises a transmitter coupler couplable to the modem transmit path and, when the optical coupling network is configured to route the calibration signal through the first loopback path, the transmitter coupler couples the modem transmit path to a modem loopback path that is coupled to the modem receive path.

17. The apparatus of claim 16, wherein when the optical coupling network is configured to route the calibration signal through the second loopback path, the transmitter coupler couples the modem transmit path to the optical transmit path.

18. The apparatus of claim 16, wherein when the optical coupling network is configured to route the calibration signal through the third loopback path, the transmitter coupler couples the modem transmit path to the calibration path and a modem loopback path that is coupled to the modem receive path.

19. A device comprising:
a means for determining a first path delay of a calibration signal routed along a first path comprising a transmission path of a modem and a receive path of the modem;
a means for determining a second path delay of the calibration signal routed along a second path comprising the receive path, the transmission path, an optical transmission path of an optical head, and an optical receive path of the optical head;
a means for determining a third path delay of the calibration signal routed along a third path comprising the receive path, the transmission path, and twice a calibration path of the optical head;
a means for determining a fourth path delay of the calibration signal routed along a fourth path comprising the receive path, the transmission path, the calibration path, and the optical receive path; and
a means for adjusting a timing delay associated with transmissions and receptions through the modem and the optical head based on the first path delay, the second path delay, the third path delay, and the fourth path delay.

20. The device of claim 19, wherein the timing delay comprises a transmitter timing delay associated with the transmissions through the optical transmission path, wherein the transmitter timing delay comprises the second path delay minus the fourth path delay plus one-half of the third path delay minus one-half of the first path delay.
